(19) United States
(12) Patent Application Publication
(10) Pub. No.: US 2008/0227924 A1
(43) Pub. Date: Sep. 18, 2008

(54) Process and System Using Nitrogen Trifluoride to Fluorinate Plastic

(75) Inventors: Michael Koonce, San Francisco, CA (US); Jurgen Poblotzki, Middletown, DE (US)

Correspondence Address: MORGAN, LEWIS & BOCKIUS, LLP, ONE MARKET SPEAR STREET TOWER, SAN FRANCISCO, CA, 94105, US

(73) Assignee: IGX Group, Inc., San Francisco, CA (US)

(21) Appl. No.: 12/013,896

(22) Filed: Jan. 14, 2008

Related U.S. Application Data
(60) Provisional application No. 60/885,554, filed on Jan. 18, 2007.

(51) Int. Cl. C08F 8/22; B01J 19/00; B29C 49/28

(52) U.S. Cl. 525/356; 422/129; 425/522

(57) ABSTRACT

Process and systems for the treatment of plastic with flourine proximally generated from nitrogen trifluoride decomposition.

### CROSS-REFERENCE TO RELATED APPLICATIONS

This application claims the benefit under 35 U.S.C. §119 of U.S. Provisional. Patent Application Ser. No. 60/885,554, filed on Jan. 18, 2007, which is incorporated by reference herein in its entirety.

### TECHNICAL FIELD

Process and systems for the treatment of plastic with flourine proximally generated from the decomposition of nitrogen triflouride.

### BACKGROUND OF THE INVENTION

Mixtures of fluorine and inert gas have been widely used in the fluorination of polyethylene and other polymetric materials. The fluorine mixture is typically made off-site at a fluorine production facility and then transported in cylinders to plastic treatment facilities. The fluorine used in treating plastics is typically produced by electrolytic separation of hydrogen fluoride (HF). The fluorine produced from HF is purified from residual HF and is packaged into high pressure cylinders as pure fluorine or as a mixture of fluorine with an inert gas. Such cylinders are marketed, for example, by Airopak™.

Decomposition of nitrogen trifluoride (NF₃) produces nitrogen and fluorine. NF₃ has been used as a source of fluorine in semiconductor and flat panel display manufacturing as a cleaning gas to remove silicon deposits in production tooling. Fluorine generated through the decomposition of NF₃ has also been used as an etching gas on silicon surfaces.

However, there is an inherent risk in the packaging, transportation, storage, and use of fluorine and fluorine gas mixtures due to the extremely corrosive nature of fluorine. These risks also pose an economic cost premium to end users.

### SUMMARY OF THE INVENTION

Nitrogen trifluoride (NF₃) is decomposed to fluorine and nitrogen in proximity to the site at which the fluorine is used to treat plastic. This eliminates the need to publically transport fluorine gas for this purpose.

NF₃ can be thermally decomposed by heating NF₃ to about 350° C. or greater. Alternatively, NF₃ can be decomposed by passing it through a plasma generator. The plasma generator in such embodiments can utilize low field toroidal technology. In another embodiment, NF₃ can be decomposed by exposing it to microwaves.

In some cases, the fluorine is diluted with an inert gas before it is used to treat the plastic. In preferred embodiments, the concentration of fluorine after dilution is between 0.1 mole. % and 50 mole %. Nitrogen, argon and neon can be used as the diluent.

The decomposition of NF₃ typically takes place within the same facility where the plastic is treated. This does not mean that the decomposition must occur under the same roof but rather that it can take place at the same facility and be transported to the plastic treatment site without the need to package the flourine and ship it publically. It is preferred that the NF₃ is decomposed in close proximity to the plastic treatment site so that the flourine so produced can be used without significant delay.

A system for treating plastic with fluorine is also disclosed. The system comprises a source of nitrogen trifluoride and a decomposition device having inlet and outlet ports where the inlet port is in fluid communication with the source of nitrogen trifluoride. The decomposition devise is capable of converting nitrogen trifluoride to nitrogen and fluorine. The system also includes a plastic treatment device in fluid communication with the outlet of the decomposition device.

In another embodiment, a tank is disposed between the decomposition device and the plastic treatment device to either store the flourine nitrogen mixture or to dilute it further by mixing with an inert gas. In the latter embodiment, the system includes a source of inert gas in fluid communication with the tank. The tank is sometimes referred to as a “mixing tank” in fluid communication with the decomposition device.

The plastic treatment device in the foregoing system can be a blow mold where the interior and/or exterior surfaces of the molded plastic object are treated with flourine to form a flourine barrier on the surface of the plastic object.

### BRIEF DESCRIPTION OF THE DRAWING

The accompanying drawing, which is incorporated in and constitutes part of this specification, and is useful in illustrating a preferred embodiment of the invention, together with the description, serves to explain the principles of the invention.

FIG. 1 is a general process flow of the conversion of NF3 into fluorine and inert gas mixtures.

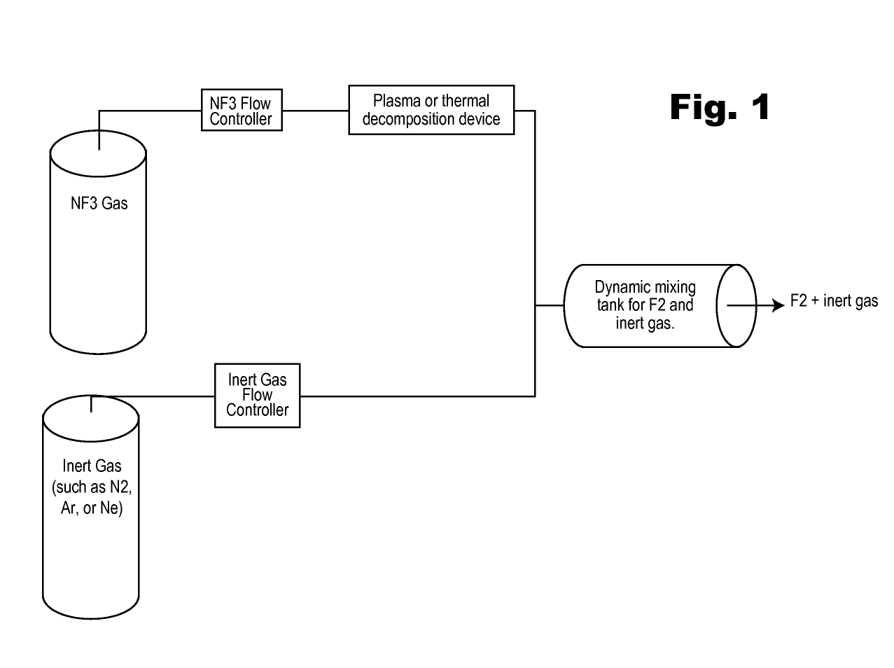

### DETAILED DESCRIPTION OF THE INVENTION

NF₃ is decomposed to fluorine in proximity to a plastic treatment site to eliminate the need to transport fluorine. The decomposition of the NF₃ through either a plasma generator or thermal oven, results in a gaseous mixture that are approximately 25% nitrogen and 750% fluorine, by molar volume, depending upon the efficiency of the NF₃ decomposition. The mixture can further be diluted with an inert gas, typically nitrogen, to mixtures of 0.1 mole % to 50 mole % of fluorine.

There are several-advantages of using NF₃ in place of fluorine/fluorine gas mixtures. The decomposition of NF₃ does not produce any hydrogen fluoride impurities which can run as high as 1% molar volume in fluorine made from HF.

In addition, NF₃ can be labeled and transported more safely as a non-flammable gas versus fluorine which is required to be labeled as Poison Gas, Oxidizer, and Corrosive. NF₃ also does not require specially treated storage containers as required for fluorine mixtures. Up to nine times more fluorine by weight can be stored in a given size high pressure container as compared to fluorine.

Further, NF₃ decomposition allows for the production of the fluorine and inert gas mixtures when needed thereby eliminating the risks of storing traditional fluorine mixtures.

NF₃ can be purchased commercially with a purity of 95% or greater. NF₃ having a purity less than 95% can be used provided the additional impurities are inert gas. Nitrogen is usually the inert gas used in these mixtures, but argon and neon can also be used. In the system, NF₃ is passed through a one of several types of devices which decomposes the NF₃ into its nitrogen and fluorine components at rates of 99% or better. Devices that can be used to decompose the NF₃ can be plasma generators using low-field toroidal technology or high-frequency microwave technology. NF₃ can also be decomposed in a thermal oven capable of generating temperatures in excess of 350° C. Low-field toroidal plasma technology can result in 100% decomposition of the NF₃.

The decomposition of NF₃ results in the production of a mixture of atomic fluorine (F), atomic nitrogen (N), molecular fluorine (F₂), and molecular nitrogen (N₂). The atomic F and N quickly forms their molecular form. The overall stoichiometric equation for the reaction is:

2NF₃->N₂+3F₂

The decomposition of the NF₃ yields a gas mixture of 75 mole % F₂ and 25 mole % N₂.

The typical fluorine and inert gas mixture used to treat plastic preferably has a fluorine content ranging between 0.1 mole % and 50 mole %. The NF₃ decomposition mixture containing 75 mole % F₂ can be diluted by the addition of gas to bring the final mixture to the desired fluorine composition. The dilution to the final mixture can be done with either manual or automatic flow controllers. A pressure regulation device may be used to control the pressure of the final mixture as it is delivered to the plastic treatment device.

The fluorine mixture can be used in applications for blow molding plastic tanks and containers designed to hold such solvents as hydrocarbons, hydrocarbon fuels, and hydrocarbon fuels with organic additives including lower alkanols and ethers. Other embodiments include the treatment of the surface of polymer plastic sheets for improved anti-blocking and adhesion properties.

What is claimed is:

1. A process for treating a plastic comprising:
(a) providing a plastic surface;
(b) decomposing nitrogen triflouride to nitrogen and fluorine; and
(c) contacting the fluorine from said decomposing step with the plastic.

2. The process of claim 1 wherein said decomposing is by thermal decomposition.

3. The process of claim 2 wherein said thermal decomposition is obtained by raising the temperature of said nitrogen trifluoride to about 350 C or greater.

4. The process of claim 1 wherein said decomposing is obtained by passing said nitrogen trifluoride through a plasma generator.

5. The process of claim 4 wherein said plasma generator utilizes low field toroidal technology.

6. The process of claim 1 wherein said decomposing is obtained by exposing said nitrogen trifluoride to microwaves.

7. The process of claim 1 wherein said fluorine is diluted by an inert gas.

8. The process of claim 7 wherein the concentration of said fluorine after dilution is between 0.1 mole % and 50 mole %.

9. The process of claim 7 wherein said inert gas is selected from the group consisting of nitrogen, argon and neon.

10. The process of claim 1 wherein said decomposing of said nitrogen trifluoride is in physical proximity to said contacting of said plastic.

11. A system for treating plastic with fluorine comprising:
(a) a source of nitrogen trifluoride;
(b) a decomposition devise having inlet and outlet ports, wherein said inlet port is in fluid communication with said source of nitrogen trifluoride and wherein said decomposition devise is capable, of converting nitrogen trifluoride to nitrogen and fluorine; and
(c) a plastic treatment devise in fluid communication with the outlet of said decomposition device.

12. A system for treating plastic with fluorine comprising:
(a) a source of nitrogen trifluoride;
(b) a decomposition devise having inlet and outlet ports, wherein said inlet port is in fluid communication with said source of nitrogen trifluoride and wherein said decomposition devise is capable of converting nitrogen trifluoride to nitrogen and fluorine;
(c) a source of inert gas;
(d) a mixing tank comprising; and
(d) a plastic treatment devise in fluid communication with the outlet of said mixing tank;
wherein said mixing tank is in fluid communication with said decomposition device, said source of inert gas and said decomposition device.

13. The system of claim 11 wherein said plastic treatment device is a blow mold.
